(19) United States
(12) Patent Application Publication
(10) Pub. No.: US 2003/0229698 A1
(43) Pub. Date: Dec. 11, 2003

(54) Data allocation method, program and computer

(76) Inventors: Ryoji Furuhashi, Yokohama (JP); Yasunori Kaneda, Sagamihara (JP); Toru Nojiri, Tokyo (JP)

Correspondence Address: MATTINGLY, STANGER & MALUR, P.C., 1800 DIAGONAL ROAD, SUITE 370, ALEXANDRIA, VA, 22314, US

(21) Appl. No.: 10/230,101

(22) Filed: Aug. 29, 2002

(30) Foreign Application Priority Data
Jun. 7, 2002 (JP) 2002-166458

(51) Int. Cl. G06F 15/173; G06F 12/00; G06F 17/30; G06F 12/16; G06F 7/00; G06F 13/00; G06F 13/28

(52) U.S. Cl. 709/226; 707/10; 711/114

(57) ABSTRACT

An information processing system has a computer, a plurality of memory devices for storing data used by a program of the computer and an allocation unit for allocating the data to a predetermined storage area for data storage. The allocation unit determines a position of a storage area for allocation on the basis of characteristic information of a memory device and volume requirement information indicative of the kind or utilization purpose of the data.

### BACKGROUND OF THE INVENTION

The present invention relates to an allocation unit for allocating data to a plurality of memory devices in an information processing system having a plurality of computers and the plurality of memory devices shared by the computers connected to them and more particularly, to a technique for selecting a storing area of memory device to which data is allocated.

With recent information technology spread widely and growth of rich media of contents, the amount of data handled by an information processing system has been increasing. In accordance therewith, the amount of data to be handled by a single application has also been increasing. The capacity of one storage for storing data is limited and therefore there is a tendency to increasing the case where data of a single application cannot be stored in a single storage.

Further, the performance required of the storage has been increasing remarkably. But, most of storage uses one or more disks and in such a storage, access time is not to fast owing to the physical rotation speed of the disk and the moving time of a read head and the performance of one storage is limited. As a result, it is frequent that the single storage cannot satisfy the required access performance.

AS countermeasures against the above two points, the following two prior arts are available.

Structurally, in the first prior art, a single application uses a plurality of physically independent HDD's (hard disk drives) are used.

FIG. 13 shows the construction of an information processing apparatus in the first prior art.

An application server 10 in which an application 40 runs, is connected to HDD's 20 and 30. The application 40 uses data storage areas 50 and 60 to store data. The data storage area 50 is allocated to the HDD 20 and the data storage area 60 is allocated to the HDD 30.

By setting the single application to cause it to use the plurality of HDD's in this manner, so large an amount of data that cannot be handled by the single HDD alone can be handled. In addition, by using the plurality of HDD's, loads on accessing can be distributed and even when the data storage areas 50 and 60 are accessed simultaneously, the access performance can be prevented from being degraded.

Next, the second prior art is so constructed as to use a large-scale RAID. In a RAID (Redundant Arrays of Inexpensive Disks), a plurality of HDD's are used to constitute a RAID group and a logical unit or units are allocated to the RAID group to realize improvements in reliability and access speed. Further, another type of RAID has a volume coupling function by which a plurality of RAID groups can be used as if they are operated with a single large-capacity logical unit and a volume dividing function by which a single RAID group is so divided as to be operated with a plurality of logical units.

When storing data the application uses in the RAID, the volume coupling function can be used to overcome the necessity for data to be divided and stored because of a shortage of capacity of memory device and besides, performance exceeding that of a single HDD can be obtained because the RAID group is constructed of the plurality of HDD's.

In the aforementioned first prior art in which data storage areas are allocated to the plurality of physically independent memory devices for the purpose of storing data, the plurality of memory devices to which the data storage areas are allocated are physically independent of each other and besides, each of the plural memory devices has a characteristic specific to it such as access performance and reliability, with the result that the relation between the characteristic and the kind or utilization purpose of data to be stored in a data storage area cannot be managed systematically. Accordingly, data accessible simultaneously are sometimes allotted to a data storage area of the physically identical memory device and disadvantageously, the access performance will be degraded.

Further, the aforementioned second prior art employs the volume coupling function and volume dividing function for the PAID to take advantage of a technique of dividing the data storage area into plural ones in consideration of distribution of access loads and assurance of reliability and allocating individual data storage areas to different logical units. In this case, in the second prior art, the plural logical units are physically independent of each other and besides, the relation between the characteristic, such as access performance or reliability, specific to each physical memory device subordinate to the plural logical units and the kind or utilization purpose of data to be stored in a data storage area is not managed systematically. Accordingly, even when the plurality of data storage areas are allocated to different logical units by using the volume dividing function, the areas actually happen to be allocated to logical units sharing the same physical memory device or disk, causing disadvantages such as degraded access performance.

### SUMMARY OF THE INVENTION

The present invention has been made in the light of the above circumstances and it is an object of the invention to improve the access performance to data and its reliability in a technique of allocating the data to a plurality of storage areas of a storage.

To accomplish the above object, an information processing system according to an embodiment of the invention comprises a computer, a plurality of memory devices for storing data used by a program of the computer and an allocation unit for allocating the data to predetermined storage areas for data storage. The allocation unit referred to herein determines a position of a storage area for allocation on the basis of characteristic information of a memory device and volume requirement information indicative of the kind or utilization purpose of the data.

Preferably, the allocation unit determines a position of a storage area of a memory device on the basis of characteristic information of memory device including at least physical identification information of each memory device and volume requirement information indicative of the kind or utilization purpose of data and besides, determines a position of a storage area in such a manner that data of the same kind or utilization purpose are allocated to physically independent memory devices.

Further, the allocation unit preferably determines a position of a storage area of a memory device on the basis of characteristic information of memory device including at least information for identifying a RAID group to which each memory device belongs and volume requirement information indicative of the kind or utilization purpose of data and besides, determines a position of a storage area in such a manner that data of the same kind or utilization purpose are allocated to memory devices belonging to different RAID groups.

Further, the allocation unit preferably determines a position of a storage area for allocation on the basis of characteristic information of memory device including at least information indicative of the number of data stored in the memory device and volume requirement information indicative of the kind or utilization purpose of the data.

Further, the volume requirement information may preferably be information for sorting the kind of data in accordance with an access rate to data.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing the construction of an information processing system to which a first embodiment of the invention is applied.

FIG. 2 is a block diagram showing the construction of an application server in the first embodiment.

FIG. 3 is a block diagram showing the construction of RAID control unit in the first embodiment.

FIG. 4 is a flowchart showing procedures for installation of an application in the first embodiment.

FIG. 5 shows a table of volume requirement information holding unit.

FIG. 6 shows a table of volume identification information holding unit.

FIG. 7 is a block diagram showing the construction of an information processing system to which a second embodiment of the invention is applied.

FIG. 8 is a block diagram showing the construction of RAID control unit in the second embodiment.

FIG. 9 is a flowchart showing procedures for installation of an application in the second embodiment.

FIG. 10 shows a table of data storage area allocation information holding unit.

FIG. 11 shows a volume requirement information converting table used by volume requirement information converting unit.

FIG. 12 shows a volume identification information converting table used by volume identification information converting unit.

FIG. 13 is a block diagram showing the construction of an information processing unit in which an application using a plurality of hard disk drives operates.

### DESCRIPTION OF THE EMBODIMENTS

<<First Embodiment>>

A first embodiment of the present invention will be described hereunder.

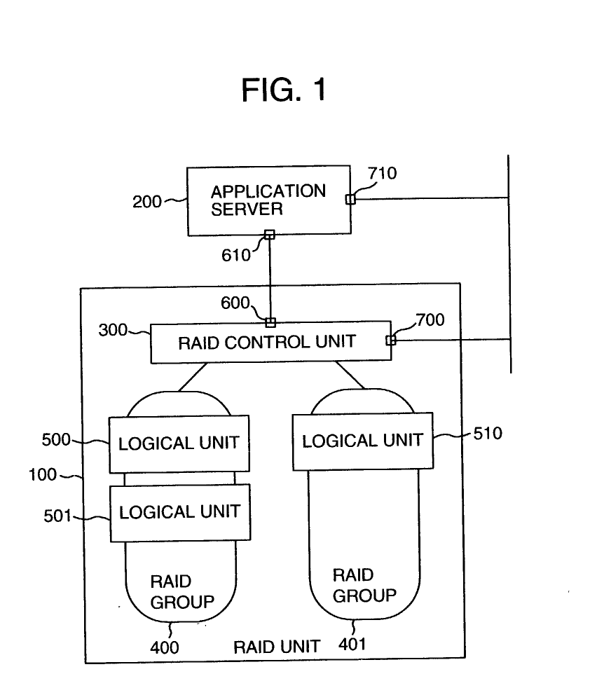

FIG. 1 shows the construction of an information processing system to which the first embodiment of the invention is applied.

A RAID unit 100 is a storage connected to an application server 200. The RAID unit 100 includes a RAID group 400 and a RAID group 401. Each of the RAID groups 400 and 401 is comprised of a plurality of physical disks. Logical units 500 and 501 are allocated to the RAID group 400 and a logical unit 510 is allocated to the RAID group 401. For the RAID groups 400 and 401, RAID control unit 300 controls read and write processes based on RAID algorithm and preparation/deletion of RAID group and preparation/deletion/expansion of logical unit. The application server 200 is connected to the RAID control unit 300 through storage access I/F 610 and external access I/F 600 to perform read/write processes from/to the storage. The application server 200 is also connected to the RAID control unit 300 through management I/F's 710 and 700 to control the RAID unit 100 in connection with preparation/deletion of RAID group, preparation/deletion/expansion of logical unit and operation of tables, to be described later, included in the RAID control unit.

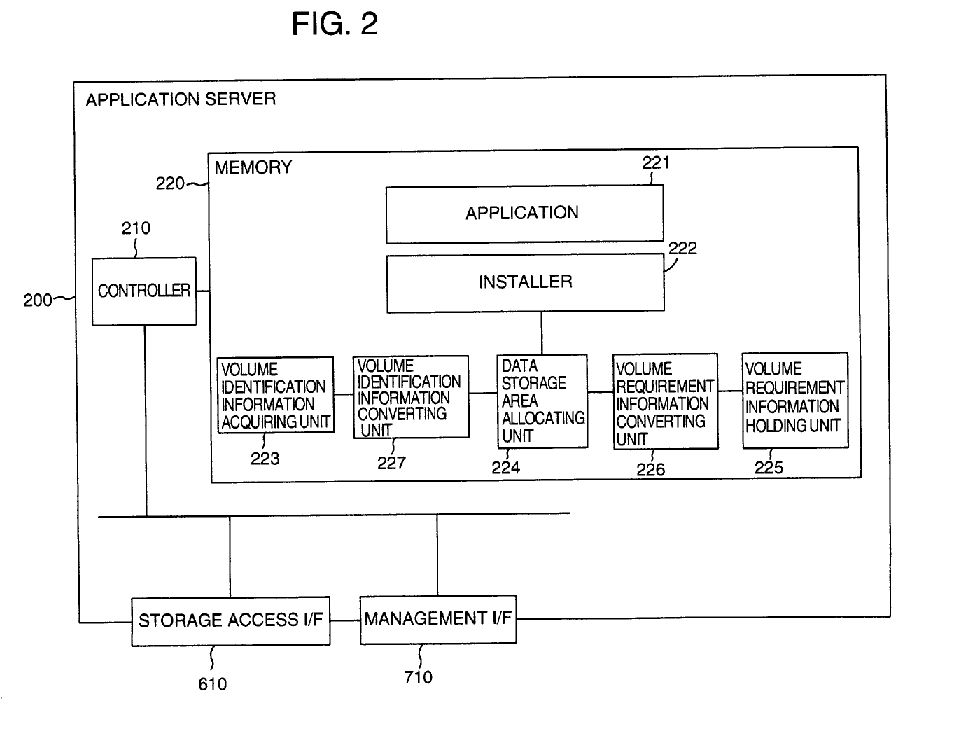

The application server 200 is constructed as will be described below with reference to FIG. 2.

The application server 200 includes a controller 210, a memory 220 connected to the controller 210, a storage access I/F 610 and a management I/F 710, the I/F's being connected to the controller 210 through an internal communication path. The memory 220 includes an application 221, an installer 222 for installing the application 221, data storage area allocating unit 224 used by the installer 222, volume identification information acquiring unit 223 and volume requirement information holding unit 225, both the units 223 and 225 being used by the data storage area allocating unit 224.

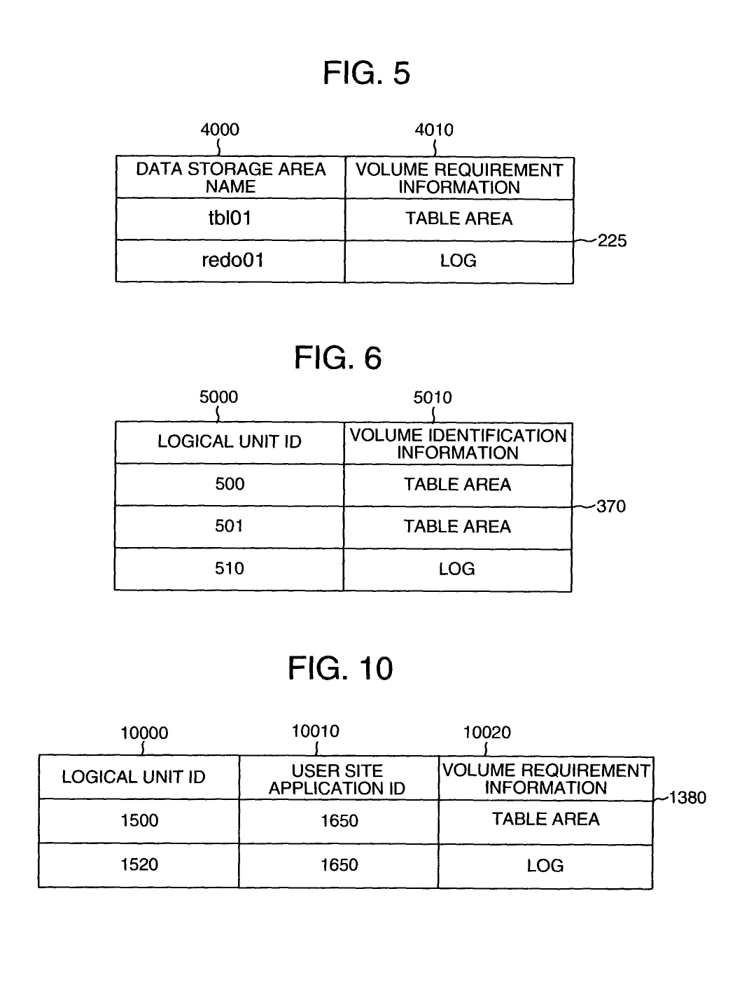

Referring to FIG. 5, the volume requirement information holding unit 225 is constructed as shown therein.

The volume requirement information holding unit 225 holds a table indicating data storage area name 4000 and volume requirement information 4010 for each value of data storage area name 4000. Held in a value of data storage area name 4000 is an address indicative of a position of a data storage area. Held in a value of volume requirement information 4010 is the kind or utilization purpose of data to be stored in the data storage area.

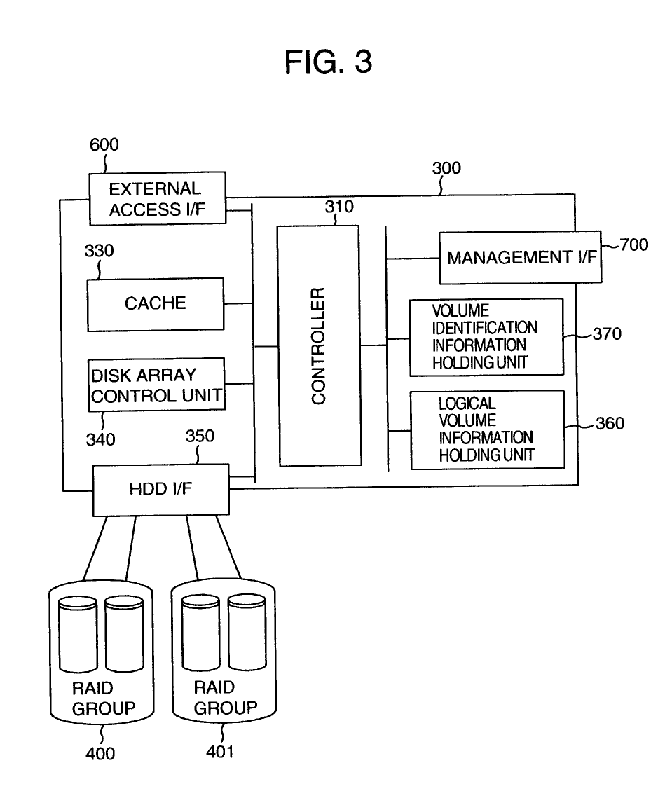

The RAID control unit 300 is constructed as shown in FIG. 3.

The RAID control unit 300 includes a controller 310, which is connected with an external access I/F 600, a cache 330, disk array control unit 340, a HDD I/F 350, logical volume information holding unit 360, volume identification information holding unit 370 and a management I/F 700. The HDD I/F 350 is connected to the RAID groups 400 and 401 each comprised of the plurality of HDD's.

Referring to FIG. 6, the volume identification information holding unit 370 is constructed as shown therein.

The volume identification information holding unit 370 holds a table indicating logical unit ID 5000 and volume identification information 5010 for each value of logical unit ID 5000. Set in a value of logical unit ID 5000 is an ID that is given to a logical unit present in the RAID unit 300 and is only one in the RAID unit 300. In the present embodiment, the logical unit ID 5000 is set in such a manner that 500 is given to the logical unit 500, 501 is given to the logical unit 501 and 510 is given to the logical unit 510, as shown in FIG. 6. In the present embodiment, the volume identification information 5010 is set with the kind or utilization purpose of data to be stored in a data storage area. Different RAID groups are selected in accordance with kinds or utilization purposes of data to be stored in data storage areas and values of volume identification information 5010 are set with kinds or utilization purposes of data to be stored in data storage areas in correspondence with values of logical unit ID 5000 corresponding to the logical units allocated to the respective RAID groups.

The data storage area allocating unit 224 reads the kind or utilization purpose of data to be allocated on the basis of the volume requirement information. Subsequently, the allocating unit 224 specifies, on the basis of characteristic information of a memory device, a position of a storage area (or a RAID group) to which the data is stored in respect of the read kind or utilization purpose. Characteristic information of memory device referred to herein includes identification information for specifying respective physical memory devices where areas in which data are to be stored are positioned (or identification information for specifying respective RAID groups where areas in which the data are to be stored are positioned) and information for specifying kinds or utilization purposes of data already stored in the respective physical memory devices. This permits the data storage area allocating unit 224 to prevent kinds of data of high access frequency from being stored in storage areas belonging to the same physical memory device (or the same RAID group), on the basis of the volume requirement information and the characteristic information of memory device.

Assumptively, a program for causing a computer to function as the volume identification information acquiring unit 223, data storage area allocating unit 224 or installer 22 is recorded on a recording medium such as CD-ROM and after being stored in, for example, a magnetic disk, loaded on the memory 220 so as to be executed. The medium for recording the program may be other memory media than CD-ROM. Further, the program may be installed from the memory medium to the computer or may be used by accessing the memory medium via a network. When installing the application in the information processing system applied with the first embodiment, data is allocated to a data storage area of RAID unit 100 by means of the data storage area allocating unit 224 in accordance with procedures to be described below.

During installation of the application, the controller 210 of application server 200 is executing the installer 222. When the execution of the installer 222 reaches a step of allocating a data storage area to the storage, the controller 210 executes the data storage area allocating unit 224.

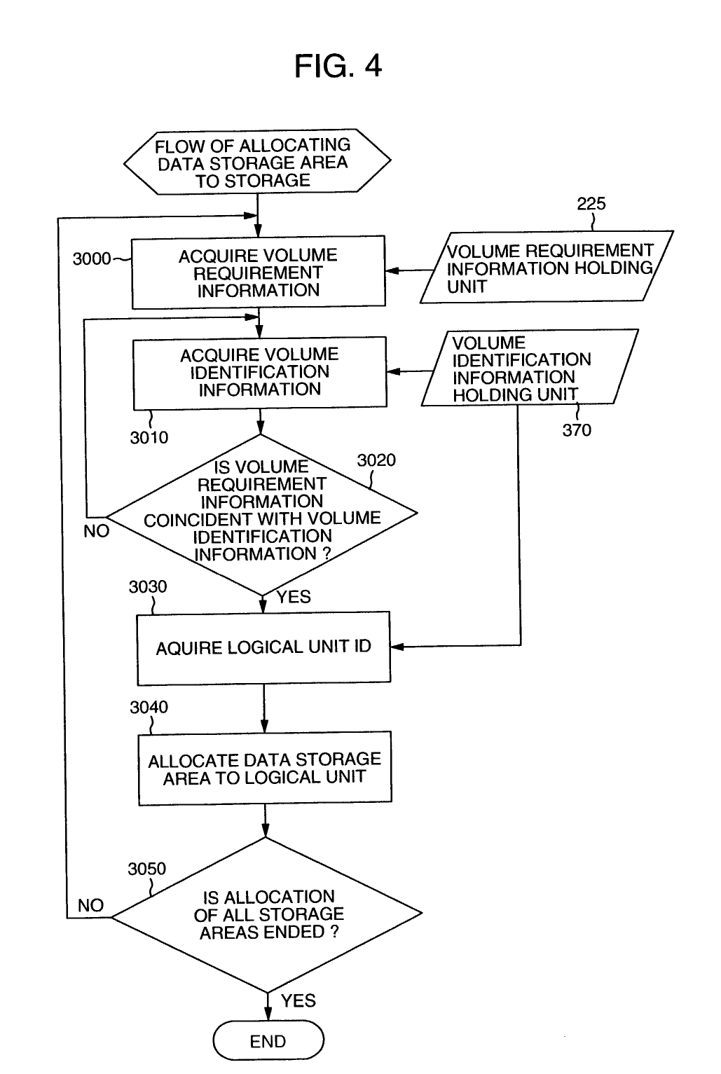

FIG. 4 shows a flowchart of an operation for allocating a data storage area to the storage when the present embodiment is applied to install the application.

The controller 210 executing the data storage area allocating unit 224 consults or makes reference to the volume requirement information holding unit 225 to acquire a value of volume requirement information 4010 (step 3000).

Thereafter, the controller 210 executes the volume identification information acquiring unit 223. The controller 210 in execution of the volume identification information acquiring unit 223 connects to the controller 310 inside the RAID control unit 300 through the medium of the management I/F 710 and the management I/F 700 inside the RAID control unit 300 to transmit a value of volume requirement information 4010 to the controller 310. Then, the controller 310 acquires a value of volume identification information 5010 from the volume identification information holding unit 370 (step 3010).

The controller 310 examines whether the value of volume requirement information 4010 sent from the controller 210 of application server 200 coincides with the acquired value of volume identification information 5010. If coincident, the process proceeds to step 3030. If the values are non-coincident with each other, the process is returned to the step 3010 (step 3020).

The controller 310 acquires a value of logical unit ID 5000 corresponding to the acquired value of volume identification information 5010 (step 3030).

Then, the controller 310 connects to the controller 210 inside the application server 200 through the medium of the management I/F 700 and the management I/F 710 inside the application server 200 to transmit the value of logical unit ID 5000 to the controller 210. The controller 210 resumes the execution of the data storage area allocating unit 224. The controller 210 in execution of the data storage area allocating unit 224 connects to the controller 310 inside the RAID control unit 300 through the medium of the storage access I/F 610 and the external access I/F 600 inside the RAID control unit 300 to send to the controller 310 the value of logical unit ID 5000 and a command to allocate a data storage area to the logical unit having that value of logical unit ID. The controller 310 allocates the data storage area to the logical unit having the logical ID transferred from the controller 210 inside the application server 200, through the medium of the HDD I/F 350 (step 3040).

When allocation of all data storage areas ends, the data storage area allocating unit 224 ends but if allocation of all data storage areas has not finished yet, a similar operation starting with the step 3000 is repeated for data storage areas of which allocation has not finished yet (step 3050).

In the first embodiment, the volume identification information present in the RAID unit is compared with the volume requirement information present in the application server and the coincidence leads to determination of a logical unit to which a data storage area is allocated. The volume identification information is preset in compliance with an application that sets up an operation environment. Thus, when installing data of an application program, a position of a suitable storage can be determined on the basis of characteristics of the storage and the kind or utilization purpose of data to be allocated to the data storage area of the storage, so that the access performance to the data can be improved and its reliability can be assured without requiring detailed knowledge of the storage.

The processing procedures of the present embodiment and effects thereof will be described by way of example of a case where database software (hereinafter simply referred to as a database) is installed.

Since the database is accessed at a time from many clients, assurance of high performance is of an important problem. To solve this problem, the present embodiment is applied to allocate a data storage area used by the database to the RAID unit.

In FIG. 1 showing the construction of the information processing system to which the present embodiment is applied, the application server 200 is a server in which the database operates. In FIG. 2 showing the construction of the application server 200, the application 221 corresponds to the database.

The database needs data storage areas for storing a table area and a log. As well known in the art, the table area and the log are accessed simultaneously and consequently, the overall performance is degraded when they are allocated to the same RAID group. Accordingly, with a view to distributing access loads on a table area data storage area and a log data storage area, the table area data storage area and the log data storage area must be allocated to different RAID groups.

Under the circumstances, the volume identification information holding unit 370 inside the RAID control unit 300 is constructed in advance as shown in FIG. 6. For example, upon shipment of a RAID unit, the volume identification information holding unit 370 is incorporated into the RAID unit in advance. A value of volume identification information 5010 corresponding to a value of 500 of logical unit ID 5000 corresponding to the logical unit 500 allocated to the RAID group 400 is set as a table area. And a value of volume identification information 5010 corresponding to a value of 510 of logical unit ID 5000 corresponding to the logical unit 510 allocated to the RAID group 401 different from the RAID group 400 to which the logical unit 500 is allocated is set as a log.

Further, the volume requirement information holding unit 225 inside the application server 200 is constructed in advance as shown in FIG. 5. For example, upon preparation of an installer of the database, the volume requirement information holding unit 225 is packaged in advance. A value of data storage area name 4000 of the table area used by the database is set as “tb101” and a value of data storage area name 4000 of the log is set as “redo01”. A value of volume requirement information 4010 corresponding to the value “tb101” of data storage area name 4000 of the table area is set as a table area. A value of volume requirement information 4010 corresponding to the value “redo01” of data storage area name 4000 of the log is set as a log.

The controller 210 of application server 200 executes the data storage unit 224 to perform allocation of data storage areas and as a result, the data storage areas are allocated as follows. The table area “tb101” is allocated to the logical unit 500. The log “redo01” is allocated to the logical unit 510. Since the logical unit 500 is allocated to the RAID group 400 and the logical unit 510 is allocated to the RAID group 401, the table area “tb101” and the log “redo01” can be allocated to different RAID groups, thus realizing distribution of access loads. In order to obtain the aforementioned effects, coincidence of identification information must be set up between a vendor for shipment of the RAID unit and a vendor for preparation of the installer of the database.

While in the present embodiment the construction has been described in which the data storage area allocating unit 224 and volume requirement information holding unit 225 are provided in the application server 200 and the volume identification information holding unit 370 is provided in the storage 100, the data storage area allocating unit 224, volume requirement information holding unit 225 and volume identification information holding unit 370 may be allocated to a computer independent of the application server 200 and storage 100.

<<Second Embodiment>>

A second embodiment of the invention will now be described.

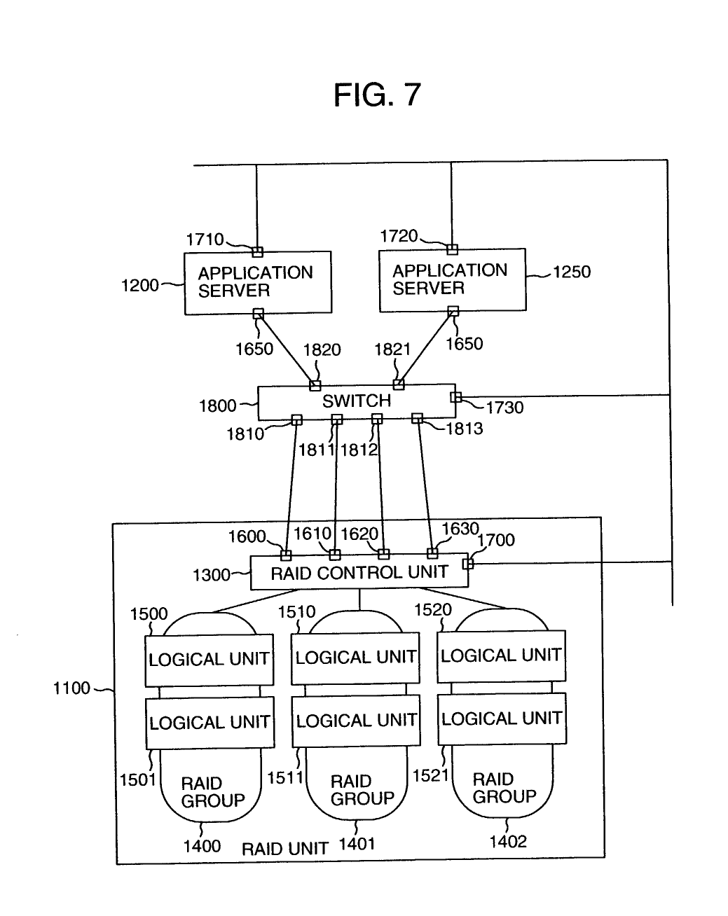

FIG. 7 shows the construction of an information processing system to which the second embodiment of the invention is applied.

The second embodiment remarkably differs from the previously-described first embodiment in that a plurality of application servers use a RAID unit and therefore make storage access to the RAID unit through a switch and the RAID control unit has a plurality of storage access I/F's.

The RAID unit 1100 is a storage connected to application servers 1200 and 1250. The RAID unit 1100 includes a RAID group 1400, a RAID group 1401 and a RAID group 1402.

Each of the RAID groups 1400, 1401 and 1402 is constructed by using a plurality of physical disks. Logical units 1500 and 1501 are allocated to the RAID group 1400. Logical units 1510 and 1511 are allocated to the RAID group 1401. Logical units 1520 and 1521 are allocated to the RAID group 1402. RAID control unit 1300 controls the RAID groups 1400, 1401 and 1402.

The application server 1200 is connected to the RAID control unit 1300 through a switch 1800 to make storage access. To access the storage, the application server 1200 sends a storage access request to the switch 1800 through storage access I/F 1650 and port 1820. Then, the switch 1800 makes reference to the contents of the storage access request and port correspondence information inside the switch to select a port, which is an object of storage access, from ports 1600, 1610, 1620 and 1630. Subsequently, the switch sends the storage access request to the RAID control unit 1300 from a port connected to the selected port (port 1810 if the selected port is port 1600, port 1811 if the selected port is port 1610, port 1812 if the selected port is port 1620 or port 1813 if the selected port is port 1630).

The application server 1200 is also connected to the RAID control unit 1300 through management I/F's 1710 and 1700 for the purpose of managing the RAID unit 1100.

Like the application server 1200, the application server 1250 is connected to the RAID control unit 1300 through storage access I/F 1660 and switch 1800 to make storage access. The application server 1250 is also connected to the RAID control unit 1300 through management I/F's 1720 and 1700 to manage the RAID unit 1100.

The application servers 1200 and 1250 are constructed similarly to the application server 200 in the first embodiment.

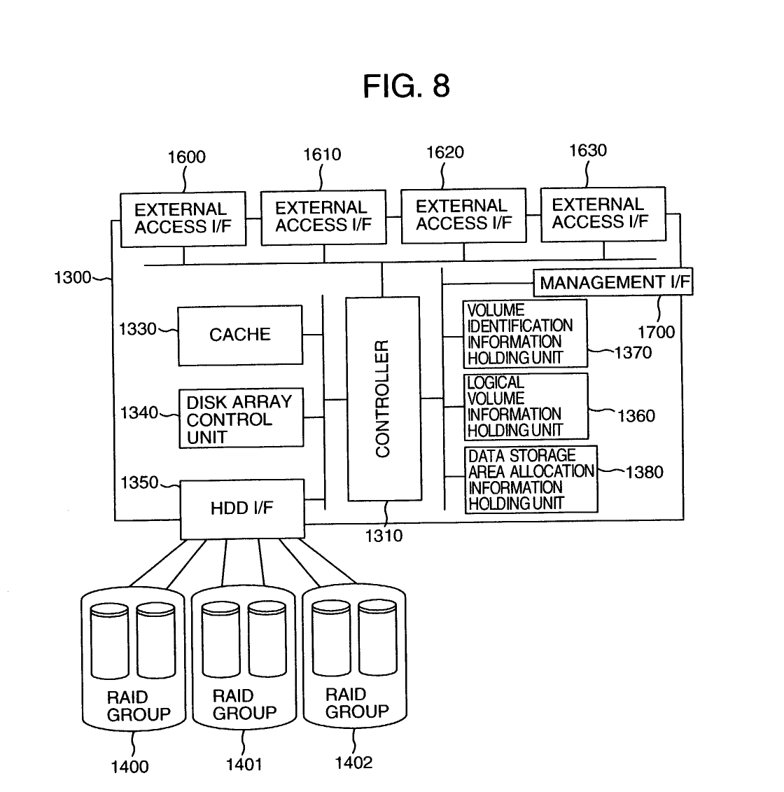

FIG. 8 shows the construction of the RAID control means 1300.

The RAID control unit 1300 includes a controller 1310, which is connected with an external access I/F group, a cache 1330, disk array control unit 1340, a HDD I/F 1350, logical volume information holding unit 1360, volume identification information holding unit 1370, data storage area allocation information holding unit 1380 and a management I/F 1700. The external access I/F group connected to the controller 1310 is comprised of external access I/F's 1600, 1610, 1620 and 1630.

The RAID control unit 1300 differs from the RAID control unit 300 in FIG. 3 in that the RAID control unit 1300 has data storage area allocation information holding unit 1380 in addition to the constituent components possessed by the RAID control unit 300 and has the plurality of external access I/F's.

FIG. 10 shows the construction of the data storage area allocation information holding unit 1380.

The data storage area allocation information holding unit 1380 is a table indicating logical unit ID 10000, user site application ID 10010 associated with each logical unit ID 10000 and volume requirement 10020 associated with each logical unit ID 10000. A value of logical unit ID 10000 is set with an ID that is given to a logical unit present in the RAID unit and is only one in the RAID unit 1300. A value of user site application ID 10010 is set with an ID that is only one throughout the information processing system of the present embodiment. A value of volume requirement information 10020 is set with volume requirement information of a data storage area allocated a logical unit corresponding to a value of 1500 of logical unit ID.

When an application is installed in the information processing system applied with the second embodiment, a data storage area is allocated to the storage in accordance with procedures described below.

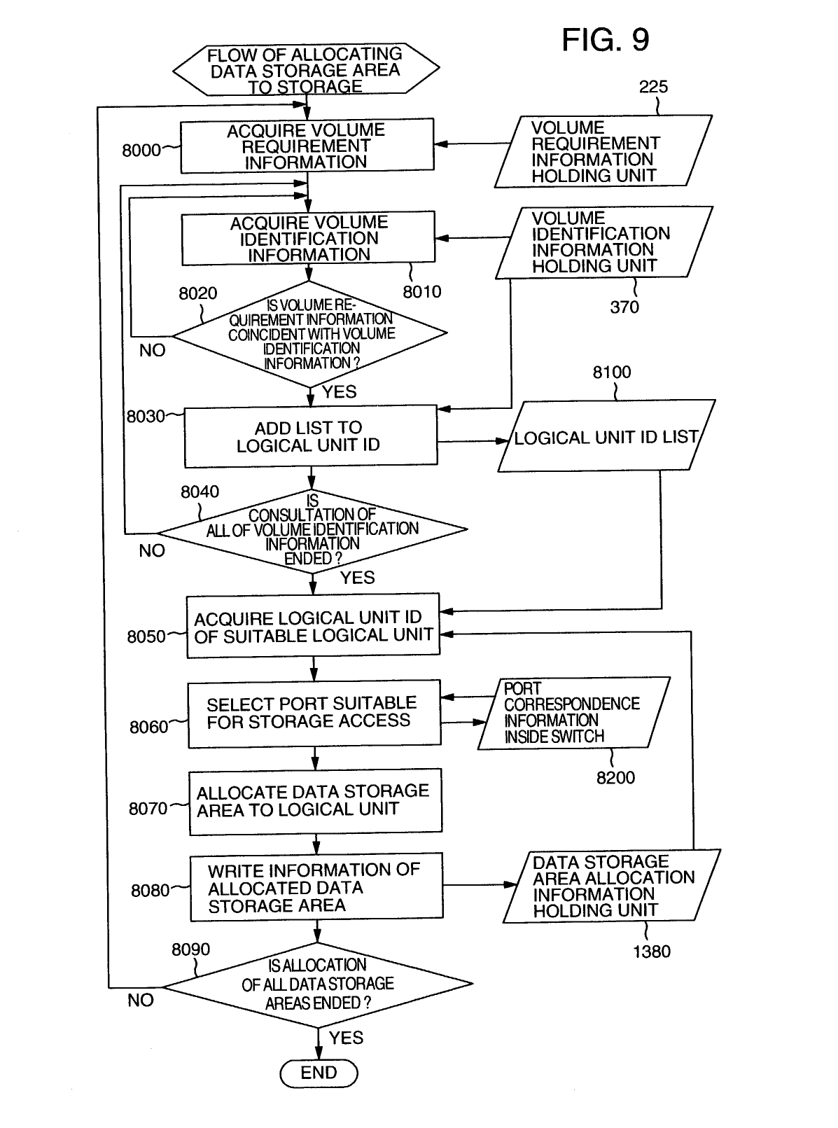

FIG. 9 is a flowchart of an operation for allocating a data storage area to the storage when the application is installed by applying the present embodiment.

When installation of an application operated by the application server 1200 reaches a step of allocating a data storage area to the storage, the application server 1200 first acquires a value of volume requirement information (step 8000).

Then, the application server 1200 connects to the controller 1310 inside the RAID control unit 1300 through the management I/F 1710 and the management I/F 1700 on the RAID control unit side to send the value of volume requirement information to the controller 1310. The controller 1310 then acquires a value of volume identification information from the volume identification information holding unit 1370 (step 8010).

The controller 1310 examines whether the value of volume requirement information sent from the application server 1200 coincides with the acquired value of volume identification information and if coincident, the process proceeds to step 8030 but if non-coincident, the process returns to the step 8010 (step 8020).

The controller 1310 acquires a value of logical unit ID corresponding to the acquired volume identification information. Then, the controller 1310 adds the acquired value of logical unit ID to a logical unit ID list 8100 (step 8030).

The above operation repeats itself until consultation of all of volume identification ends. If consultation of all of volume identification does not end, the process returns to the step 8010 to repeat the steps for different volume identification information. If consultation of all of volume identification information has finished, the process proceeds to step 8050 (step 8040).

The controller 1310 makes reference to the data storage area allocation information holding unit to select and acquire a value of logical unit ID of a suitable logical unit from values of logical unit ID present in the logical unit ID list 8100 (step 8050).

The controller executing the data storage area allocating means inside the application server 1200 connects to the switch 1800 through the management I/F 1710 and switch management I/F 1730 to make reference to port correspondence information 8200 inside the switch 1800. Then, the controller selects a port suitable for access to the allocated data storage area and records, on the port correspondence information 8200 inside the switch, the port 1820 connected with the application server and information for making correspondence with the selected port (step 8060).

The controller 1310 sends the acquired value of logical unit ID to the application server 1200. The application server 1200 connects to the RAID control unit 1300 through the storage access I/F 1650 and switch 1800 to send to the controller 1310 the received value of logical unit ID and a command to allocate the data storage area to a logical unit corresponding to that value of logical unit ID. The controller 1310 allocates the data storage area to the logical unit through the HDD I/F (step 8070).

The controller 1310 inside the RAID control unit 1300 records, on the data storage area allocation information holding unit 1380, the value of logical unit ID of the logical unit allocated with the data storage area, the application ID of the application operated by the application server 1200 and the volume requirement information sent from the application server 1200 (step 8080).

The above operation repeats itself until allocation of all data storage areas ends. If allocation of all data storage areas has not finished yet, a similar operation starting with the step 8000 is repeated for data storage areas of which allocation has not finished yet (step 8090).

In the above-described second embodiment, the volume identification information present in the RAID unit is compared with the volume requirement information present in the application server and from logical units for which the coincidence is set up, a logical unit suitable for allocation of the data storage area is determined by using the data storage area allocating information. Further, a port suitable for storage access is selected from the plurality of ports possessed by the RAID control unit 1300 and the port correspondence information of switch is set such that the correspondence can be made between the selected port and the port connected with the application server.

For example, when allocating a data storage area that requires high access performance, the data storage area allocating information is consulted so that the data storage area may be allocated to a logical unit for which the number of allocated data storage areas is the least. Also, the port correspondence information of switch is set in such a way that the port correspondence information inside the switch is consulted to select a port which is used by a minimal number of storages and the correspondence can be made between the selected port and the port connected with the application server. In the first embodiment, when the plurality of applications are present, it happens that data storage areas imposed with high loads in the individual applications are allocated to the same RAID group. By applying the second embodiment, however, access loads can be distributed without fail even when the plural applications are present.

For example, when an additional data storage area is allocated to expand a certain data storage area, the data storage area allocating information is consulted to determine a logical unit, to which the data storage area is allocated, in such a manner that the additional data storage area is as continual to the original data storage area as possible or both the data storage areas are allocated to the same RAID group as possible. Then, by using the volume coupling function possessed by the RAID unit, the additional data storage area is coupled to the original data storage area, thereby ensuring the expansion of data storage area. Also, the port correspondence information inside the switch is consulted to set the port correspondence information of switch by performing the port selection such that a port used for access to the additional data storage area does not differ from that used for access to the original data storage area. This can prevent an area resulting from the data storage area expansion from suffering from discontinuity leading to degraded access performance.

>>Third Embodiment>>

A third embodiment of the invention will now be described.

In the first and second embodiments, for the sake of examining the coincidence of the volume requirement information with the volume identification information, it is necessary for the volume requirement information and volume identification information to be set in advance so as to meet an application upon shipment of a product, for instance. Further, as described previously, the coincidence of the volume requirement information with the volume identification information must be set up between a vendor for shipment of the RAID unit and a vendor for preparation of an installer of the application.

The third embodiment differs from the first and second embodiments in that there are provided volume requirement information converting unit 226 and volume identification information converting unit 227 for converting the volume requirement information and volume identification information, respectively. The volume requirement information converting unit 226 and volume identification information converting unit 227 are executed by the data storage area allocating unit during a step preceding the step of examining the coincidence of the volume requirement information with the volume identification information.

By providing the volume requirement information converting unit 226 and volume identification information converting unit 227, the volume requirement information and volume identification information preset during, for example, shipment of products can be allowed to comply with a plurality of kinds of applications. Further, by customizing the volume requirement information converting unit 226 and volume identification information converting unit 227, allocation of data storage area can be permitted even if the coincidence of the volume requirement information with the volume identification information is not set up between vendors. Furthermore, when the volume requirement information and volume identification information are expressed in terms of information indicative of the range of access performance and the range of cache capacity, they can be converted, by means of the volume requirement information converting unit 226 and volume identification information converting unit 227, into information for determining a volume to which the data storage area is allocated, thus ensuring that the allocation of data storage area can be carried out.

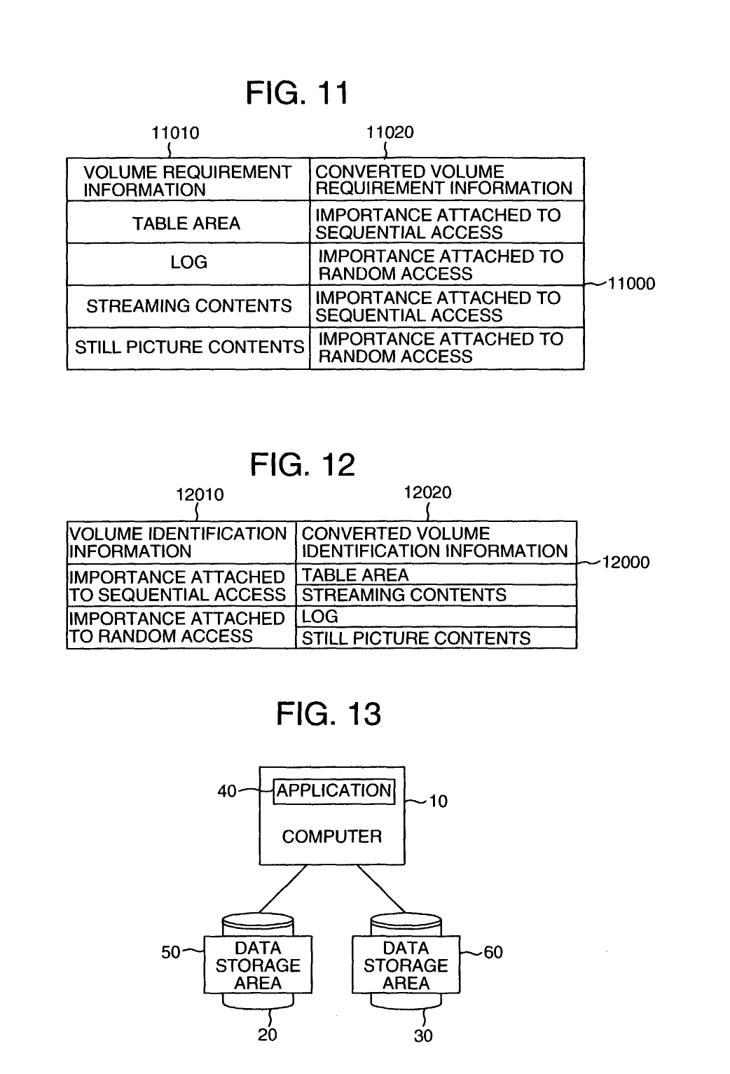

FIG. 11 shows the structure of a volume requirement information converting table 11000 used by the volume requirement information converting unit 226. The volume requirement information converting table 11000 is a table comprised of two items of volume requirement information 11010 and converted volume requirement information 11020. The volume requirement information converting unit 226 retrieves a value of volume requirement information 11010 coincident with given volume requirement information and returns a corresponding value of converted volume requirement information 11020. The data storage area allocating unit uses the returned value of converted volume requirement information 11020 to examine the coincidence of the volume requirement information with the volume identification information.

FIG. 12 shows the structure of a volume identification information converting table 12000 used by the volume identification information converting unit 227. The volume identification information converting table 12000 is a table comprised of two items of volume identification information 12010 and converted volume identification information 12020. The volume identification information converting unit 227 retrieves a value of volume identification information 12010 coincident with given volume identification information and returns a list of corresponding values of converted volume identification information 12020. The data storage area allocating unit uses the list of values of the returned converted volume identification information 12020 to examine the coincidence of the volume requirement information with the volume identification information.

An example of allocation of data storage areas carried out by applying the present embodiment in a plurality of kinds of applications will be described below.

As an application in which data storage areas are allocated to the memory device, a database and contents distribution software are available. The kind of data storage area used by the database includes a table area and a log and the kind of data storage area used by the contents distribution software includes streaming contents and still picture contents. The data storage areas of the table area and streaming contents are often subject to sequential access and the data storage areas of the log and still picture contents are often subject to random access.

Then, the volume requirement information converting table 11000 used by the volume requirement information converting unit 226 is structured in advance as shown in FIG. 11. In correspondence with a value of volume requirement information 11010 termed table area, a value of converted volume requirement information 11020 termed importance attached to sequential access is set. In correspondence with a value of volume requirement information 11010 termed log, a value of converted volume requirement information 11020 termed importance attached to random access is set. In correspondence with a value of volume requirement information 11010 termed streaming contents, a value of converted volume requirement information 11020 termed importance attached to sequential access is set. In correspondence with a value of volume requirement information 11010 termed still picture contents, a value of converted volume requirement information 11020 termed importance attached to random access is set.

On the other hand, the volume identification information holding unit 370 holds volume identification information termed importance attached to sequential access or importance attached to random access in respect of each logical unit. The data storage area allocating unit 224 compares the value of volume identification information with the value of converted volume requirement information 11020 and allocates a data storage area by examining the coincidence.

By executing the volume requirement information converting unit 226 before execution of the data storage area converting unit, the data storage area of table area can be allocated to a volume having high sequential access performance and the data storage area of log can be allocated to a volume having high random access performance when the database is installed. Also, when installing the contents distribution software, the data storage area of streaming contents can be allocated to a volume having high sequential access performance and the data storage area of still picture contents can be allocated to a volume having high random access performance. In this manner, with the single volume requirement information holding unit and the single volume identification information holding unit, the plurality of applications can be dealt with.

In the above embodiment, it is decided on the basis of the kind or utilization purpose of data whether the data has high sequential access performance and a position to which a data storage area is allocated is determined. But another type of data storage construction may be adopted in which access performance is measured in respect of the kind of data in the allocating unit and a storage area in which data is stored (or a RAID group in which data is stored) may be determined on the basis of the measurement result. Through this, the allocating unit can grasp the access performance more suitably in respect of the kind of data and consequently, the access performance to the data can be improved and its reliability can be assured.

According to the information processing system of the invention, in the technique of allocating data to the plural data storage areas of the storage, the access performance to the data can be improved and its reliability can be assured.

In all above-mentioned embodiments, one or more units shown in the drawings may be implemented by software (computer program) under the control of a computer, or may be implemented by specific hardware circuit.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. An information processing system comprising:
a computer;
a plurality of memory devices for storing data used by a program of said computer; and
an allocation unit for allocating said data to predetermined storage areas for data storage,
wherein said allocation unit determines a position of a storage area for allocation on the basis of characteristic information of a memory device and volume requirement information indicative of the kind or utilization purpose of said data.

2. An information processing system comprising:
a computer;
a plurality of memory devices for storing data used by a program of said computer; and
an allocation unit for allocating said data to predetermined storage areas for data storage,
wherein said allocation unit determines a position of a storage area of a memory device on the basis of characteristic information of memory device including at least physical identification information of each memory device and volume requirement information indicative of the kind or utilization purpose of said data.

3. An information processing system according to claim 2, wherein said allocation unit determines a position of a storage area in such a manner that data of the same kind or utilization purpose are allocated to physically different memory devices.

4. An information processing system comprising:
a computer;
a plurality of memory devices for storing data used by a program of said computer; and
an allocation unit for allocating said data to predetermined storage areas for data storage,
wherein said allocation unit determines a position of a storage area of a memory device on the basis of characteristic information of memory device including at least information for identifying a RAID group to which each memory device belongs and volume requirement information indicative of the kind or utilization purpose of said data.

5. An information processing system according to claim 4, wherein said allocation unit determines a position of a storage area in such a manner that data of the same kind or utilization purpose are allocated to memory devices belonging to different RAID groups.

6. An information processing system comprising:
a computer;
a plurality of memory devices for storing data used by a program of said computer; and
an allocation unit for allocating data to predetermined storage area for data storage,
wherein said allocation unit determines a position of a storage area for allocation on the basis of characteristic information of memory device including at least information indicative of the number of data stored in said memory device and volume requirement information indicative of the kind or utilization purpose of said data.

7. An information processing system according to claim 1, wherein said volume requirement information is information for sorting the kind of data in accordance with an access rate to data.

8. A computer connected to a plurality of memory devices for storing data used by a program, comprising:
an allocation unit for determining a position of a storage area of a memory device on the basis of characteristic information of said memory device and volume requirement information indicative of the kind or utilization purpose of said data.

9. A computer connected to a plurality of memory devices for storing data used by a program, comprising:
an allocation unit for determining a position of a storage area of a memory device on the basis of characteristic information of memory device including at least physical identification information of each memory device and volume requirement information indicative of the kind or utilization purpose of said data.

10. A computer according to claim 9, wherein said allocation unit determines a position of a storage area in such a manner that data of the same kind or utilization purpose are allocated to physically different memory devices.

11. A computer connected to a plurality of memory devices for storing data used by a program, comprising:
an allocation unit for determining a position of a storage area for allocation on the basis of characteristic information of memory device including at least information indicative of the number of data stored in said memory device and volume requirement information indicative of the kind or utilization purpose of said data.

12. A computer according to claim 9, wherein said volume requirement information is information for sorting the kind of data in accordance with an access rate to data.

13. A data allocation method for allocating data to predetermined storage areas for data storage in respect of a plurality of memory devices for storing the data used by a program of a computer, comprising the steps of:
determining a position of a predetermined storage area on the basis of characteristic information of a memory unit and volume requirement information indicative of the kind or utilization purpose of said data; and
allocating said data to the position of said predetermined storage area.

14. A program for causing a computer to function as means for allocating data to predetermined storage areas for data storage in respect of a plurality of memory devices for storing the data used by a program of a computer, comprising:
means for determining a position of a predetermined storage area on the basis of characteristic information of a memory device and volume requirement information indicative of the kind or utilization purpose of said data; and
means for allocating said data to the position of said predetermined storage area.

15. A recording medium for recording a program adapted to cause a computer to function as means for allocating data to predetermined storage areas for data storage in respect of a plurality of memory devices for storing the data used by a program of said computer, comprising:
means for determining a predetermined position of a storage area on the basis of characteristic information of a memory device and volume requirement information indicative of the kind or utilization purpose of said data; and
means for allocating said data to said predetermined position of the storage area, said recording medium recording the program for functioning said allocation unit and being readable by the computer.
